(19) United States
(12) Patent Application Publication
(10) Pub. No.: US 2010/0179893 A1
(43) Pub. Date: Jul. 15, 2010

(54) System for controlling the charge rate of an electric vehicle battery by a third party, and monitoring, recording, and reporting the power supplied to it.

(76) Inventors: Tonya Marie Burke, San Jose, CA (US); John Patrick Burke, San Jose, CA (US); Kayci Leinani Griffith, San Jose, CA (US)

Correspondence Address: Tonya Burke;John Burke, 2330 Four Seasons Court, San Jose, CA, 95131, US

(21) Appl. No.: 12/686,380

(22) Filed: Jan. 13, 2010

Related U.S. Application Data
(60) Provisional application No. 61/144,461, filed on Jan. 14, 2009.

(51) Int. Cl. G06Q 30/00; G06F 7/00; G06Q 40/00; G06F 1/26

(52) U.S. Cl. 705/31; 701/22; 700/295

(57) ABSTRACT

A system and means for controlling, monitoring, recording and reporting the use of power supplied for battery charging in electrically powered vehicles and their batteries; for the purposes of adjusting power loading on the electrical supply system, as well as allowing monitoring, recording, reporting and billing for such power use, and for recording, reporting and billing local and federal taxes for use of such electrical energy used for vehicle propulsion purposes.

### CROSS-REFERENCE TO RELATED APPLICATIONS

None.

### FEDERALLY SPONSORED RESEARCH

None.

### SEQUENCE LISTING

None.

### FIELD OF THE INVENTION

This invention described below relates to electrically propelled vehicles.

The invention concerns a system and method of enabling, monitoring and controlling the charge rate of a vehicle/battery by an external third party in order to enable the following:

1 Controlling power loading of the grid by controlling the charge rate of electric vehicles/batteries.

2 Enabling sliding scale billing rates for the energy supplied for charging the vehicle/battery, dependent on power availability.

3 Enabling monitoring and reporting of the energy supplied and used for the purpose of vehicle propulsion, for the reason of calculating tax for energy usage for transportation purposes.

### BACKGROUND OF THE INVENTION

Many vehicles now have the facility for either part electric, or full electric propulsion. Some of these vehicles have the facility to charge up the battery from an external power source. Some vehicles will have interchangeable batteries.

Whether the battery is fixed or interchangeable, as more and more vehicles convert over to electric propulsion, more loads will be placed on the power system by the requirement for vehicle/battery charging.

Currently, there are electrical vehicle charging stations in various areas, notably in parking structures at locations such as airports. In general though, the vehicles are charged at the owner/driver's residence or workplace.

In none of the current electric vehicle/battery charging methods is there a provision for controlling the charge rate of the battery dependent on the power availability of the grid.

In none of the current vehicle/battery charging systems is there a means of monitoring power used for the purposes of vehicle propulsion, in order to accurately monitor, record and report taxes and charges required by local and federal authorities to replace current gasoline powered vehicle taxes, which are normally paid by way of a per unit charge on gasoline and other fuels.

### SUMMARY

The system and means described below make possible the control of charge rate of electrically propelled vehicles/batteries within a given geographic electrical supply area, in order to control the loading on the electrical grid system. The invention is able to control individual vehicle/battery charging rates dependent on a sliding scale billing system of payments. The invention enables monitoring of energy supplied for vehicle propulsion purposes, in order that such usage may be monitored, reported, billed and taxed accordingly.

Definitions—List of Terms

Term: Charge cycle.

Definition: A period of time during which a vehicle/battery is receiving power for charging.

Term: Charge rate or charging rate.

Definition:

The rate at which a battery is charged up from one level of stored electrical energy to a higher stored level of electrical energy from a power source. The higher the charge rate, the less time taken to fully charge the battery.

Term: Control system.

Definition: A device or set of devices to manage, command, direct or regulate the behavior of other devices or systems.

Term: Charging point.

Definition:

A connection point to a power source used for providing power for the charging of an electric vehicle/battery.

Term: Charging stations.

Definition:

Charging points provided specifically for the purposes of charging an electric vehicle/battery.

Term: Control and monitoring system.

Definition:

A system used for the monitoring and control of the charging rate of a vehicle/battery.

Term: Data transmission.

Definition: A data transmission is a method of electronic signaling which may be carried out via any convenient means such as, but not restricted to, wire transmission, local or wide area networks, internet communication, telephony, wireless communication, satellite link or other means of achieving a communications link.

In this disclosure the term data transmission is represented in the diagrams by the following symbols:

1:

[symbol]

2:

[symbol]

[symbol]

Term: Electrically propelled vehicle or vehicles.

Definition:

A vehicle that can be propelled by means of an electric motor, using energy stored in a battery.

Term: Geographic electrical supply area or areas.

Definition:

A geographic area or areas supplied with electrical power and defined by a power provider.

Term: Geographic location.

Definition:

The physical location; as in a physical street address, a set of GPS (Global Positioning System) co-ordinates or a map reference.

Term: Geographic power distribution.

Definition:

A term used to describe the distribution of power by the power provider between Geographic electrical supply areas.

Term: Grid.

Definition:

See Power network.

Term: Individual vehicle/battery charge rate.

Definition:

A term used to describe a charging rate authorization sent out in a data communication to an individual vehicle/battery.

Term: Individual vehicle/battery sliding scale billing.

Definition:

A sliding scale of charges for the use of electrical power for charging a specific vehicle/battery. A higher sliding scale billing generally would cost more per unit of energy than a low sliding scale billing. This sliding scale charge may be chosen by the owner/driver of the vehicle/battery—in general a high charging rate requirement being charged at a higher rate per unit of energy than a low charging rate requirement.

Term: Owner/driver

Definition:

The person or persons to whom the vehicle/battery energy use is attributed and billed to.

Term: Power Grid.

Definition:

See Power network.

Term: Power Network.

Definition:

The geographic power distribution network of a power provider sometimes referred to as a grid or power grid.

Term: Power provider or providers.

Definition:

A company or companies dealing in the provision and/or sale of electrical power.

Term: Power provider location.

Definition: A location from which data signals are sent out to control vehicle/battery charge rates and also receive and record power usage of same, as well as vehicle/battery data for the purposes of billing and taxation.

Term: Power source.

Definition:

A supply of electrical power that can be used for the purposes of charging an electric vehicle/battery.

Term: Power supply.

Definition:

A supply of electrical power that can be used for the purposes of charging an electric vehicle/battery.

Term: Request for power.

Definition:

A data transmission from a vehicle/battery requesting power from a power provider.

Term: Sliding scale billing.

Definition:

A scale of charges by which the power supplied may be charged at a higher or lower rate depending on power availability. For low power availability, high power requirements supplied being billed at a higher per unit rate than low power requirements supplied.

Term: Supply point.

Definition:

A connection point to a power source used for providing power for the charging of an electric vehicle/battery.

Term: Third party location.

Definition: A location from which data signals are sent out to control vehicle/battery charge rates; and also receive and record power usage, as well as vehicle/battery data, geographic location data and any other data required for the purposes of billing and taxation. This is typically a power provider location but also may be a location provided by local or Federal government for the purposes of monitoring tax, vehicle/battery power usage and vehicle/battery data.

Term: Vehicle.

Definition:

Any form of transportation which can be legally driven on a public road system.

Term: Vehicle battery.

Definition:

A battery that is being used for the provision of propulsion power for an electric vehicle. Such batteries may be charged while attached to the vehicle but in some cases may be charged externally from the vehicle.

Term: Vehicles/batteries or Vehicle/battery.

Definition:

An electrically propelled vehicle or battery used for the provision of propulsion power for an electrically propelled vehicle.

Term: Vehicle/battery data.

Definition:

Data relating to the vehicle or battery being charged. This will include unique identifications for the vehicle and battery and also can contain other information such as registered owner address, odometer reading, power use history, geographic location data and any other data required for the purposes of billing and taxation.

Term: Vehicle/battery identification.

Definition:

A unique identification for a vehicle or a vehicle battery. An example of this would be the VIN number on an automobile.

Term: Vehicle/battery charging control system or systems.

Definition:

A control system which receives signals from a third party and adjusts the rate of charge of a vehicle/battery according to the instructions contained in the signals received.

Term: Vehicle/battery exemption.

Definition:

A vehicle/battery that has been exempted from battery power supply charge rate restrictions due to use. As an example, these would be emergency vehicles.

Term: Vehicle/battery sliding scale billing subscription.

Definition:

A subscription by the vehicle/battery owner/driver that allows a choice of payment levels for vehicle/battery charging. Generally the higher the cost per unit of energy, the faster the charging rate of the vehicle/battery.

### BRIEF DESCRIPTION OF THE DRAWINGS

FIG. 1 is a diagram describing the invention and the way in which the control system of the power provider interacts with individual vehicles/batteries.

FIG. 2 is a diagram describing an overview of the application of the invention in different geographic areas with vehicles/batteries subscribed at different sliding scale billing rates and including exempt vehicles/batteries.

FIG. 3 is a diagram describing the way in which the individual vehicles/batteries communicate with, and are monitored and controlled by, the control system of the power providers.

FIG. 4 is a diagram describing the way in which the control system of the power provider controls and monitors individual vehicles/batteries, records power usage, and generates billing for power usage and taxation purposes.

FIG. 5 is a diagram describing the control system of the invention based at the vehicle/battery location.

FIG. 6 is a diagram describing the control system of the invention based at the power provider location.

### DETAILED DESCRIPTION OF THE INVENTION

In use the invention takes the form of a monitoring and control system for the power provider to be able to remotely control the charge rate of, record the amount of power used by, and battery charging rate available to, an electric vehicle/battery.

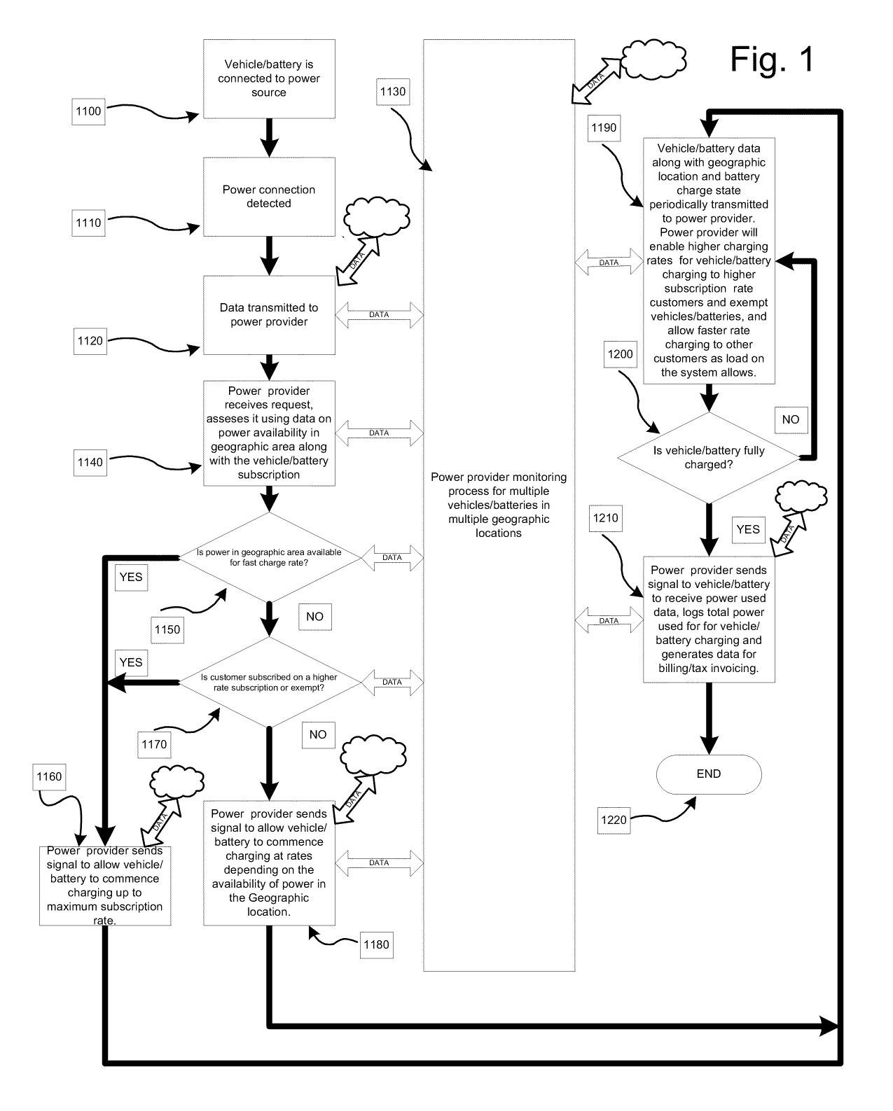

FIG. 1 illustrates an embodiment showing a high level view of the process of the interaction between the power provider control system and an individual vehicle/battery. Many of these interactions will take place concurrently, as vehicles/batteries connect to and eventually disconnect from the power supply providers power network.

In 1100 a vehicle/battery is connected to a power source for the purposes of charging the battery. In 1110 the power connection is detected and in 1120, data on the geographic location of the vehicle/battery, the vehicle/battery data and any other required information are sent via a data transmission to the power supply provider's control and monitoring system 1130. The data transmission may be via any convenient means such as, but not restricted to, internet, telephony, wireless communication, satellite link or other available means for achieving a communications link. This is detailed in the definitions section of this document and is hereinafter in this disclosure referred to as “data transmission” without any further references to definition.

In 1140 the power provider control and monitoring system 1130 receives the request for power. In 1150 a decision is made on the individual vehicle/battery charge rate based on power availability in the geographic location of the vehicle/battery being charged. If power is available for fast charging, the control system sends out a data transmission at 1160 to the vehicle/battery charging control system, allowing the vehicle/battery to be charged at any rate chosen by the vehicle/battery owner/driver.

If at 1150 power availability is lower than the level that would allow the vehicle/battery to charge at a fast rate, the power provider's control and monitoring system 1130 reviews at 1170 the data for the individual vehicle/battery, which may have been subscribed at a higher sliding scale billing rate, and also checks whether the vehicle/battery is exempt from charging rate restrictions, such as for Government or emergency vehicles/batteries. If the vehicle/battery is subscribed on a higher sliding scale billing rate or is exempt, the control system at 1160 sends out a data transmission to the vehicle/battery allowing the vehicle/battery to be charged at any rate chosen by the owner/driver.

If, as a result of the review at 1170, the vehicle/battery is not subscribed at a higher sliding scale billing rate and is not an exempt vehicle/battery, the control system at 1180 sends out a data transmission to the vehicle/battery allowing it to be charged at a rate determined by the power provider, based on geographical power loading and availability.

At 1190, the power provider control and monitoring system 1130 reviews available power in the geographic locations on a continuous basis and from time to time may either send out a data transmission allowing vehicles/batteries to increase their charge rates, or decrease their charge rates depending on geographic area power availability.

The vehicle/battery eventually will be fully charged and the charging control system based at the vehicle/battery will send out a data transmission indicating that the battery is fully charged. If this “fully charged” data transmission for an individual vehicle/battery is received, the power provider control and monitoring system 1130 reviews at 1200 the data for the individual vehicle/battery and at 1210 sends out a data transmission to receive data on power used by the vehicle/battery and ends the charge cycle for the individual vehicle/battery. The power provider control and monitoring system then generates and stores data for power usage, as well as vehicle/battery data, sliding scale billing rate information, geographic location data and any other data required for the purposes of billing and taxation. This will end at 1220 the control and monitoring sequence for an individual vehicle/battery for this charge cycle, until power is again requested.

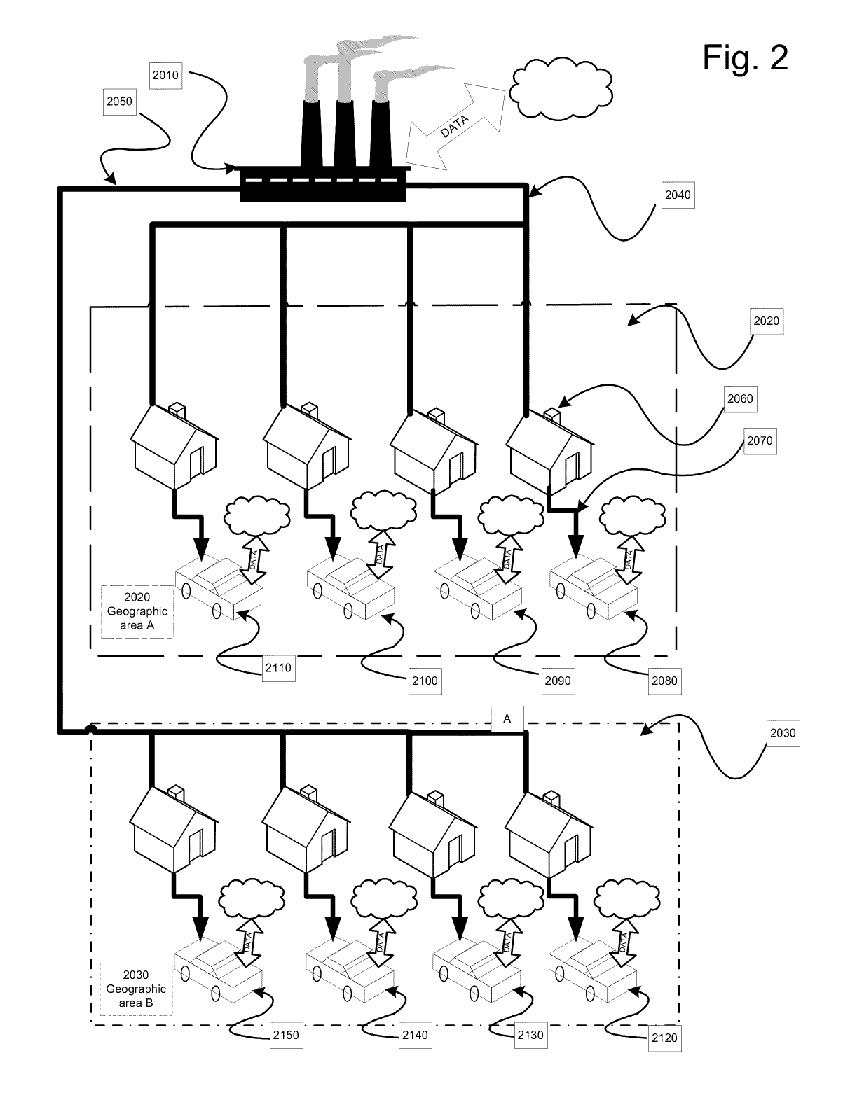

FIG. 2 describes an overview of the application of the invention in different geographic areas with vehicles/batteries subscribed at different sliding scale billing rates, and including exempt vehicles. The Geographic areas A and B listed as 2020 and 2030 in the diagram are represented by the dotted/dashed boundary lines around each area. In this illustration only 4 vehicles/batteries are shown in each of two geographic areas connected to 4 supply points in each area. This is for illustration only, as in practice many vehicles/batteries being supplied by many power supply points in many geographic areas will be monitored and controlled. For the purposes of illustration these charging points have been shown as buildings, but in practice may be a charging point in a parking lot, charging station, roadside charging point or other place where an electric vehicle/battery may be connected to a power source in order to charge it. For clarity, only one charging point 2060, with one connection point 2070 derived from the power provider power line 2040, is referenced in FIG. 2, shown connected to vehicle/battery 2080 in geographic area A 2020. Vehicles/batteries 2090, 2100 and 2110 are connected in a similar manner, as are the vehicles/batteries 2120, 2130, 2140 and 2150 in area B 2030, although those vehicles/batteries are connected by the power feeds derived from area B 2030 through charging points supplied by power provider line 2050.

A power provider 2010 is receiving data transmissions from a number of vehicles/batteries in geographic area A 2020. At the same time, the power provider 2010 is receiving data transmissions from a number of vehicles/batteries in geographic area B 2030. Each of these data transmissions contains vehicle/battery data, geographic location data and any other data required for the purposes of billing and taxation. The power provider is able to monitor power usage in each of the areas supplied by the power feeds provided to area A 2020 by power line 2040 and also able to monitor power usage in area B 2030 by power line 2050.

Each of the vehicles/batteries in area A 2020 are connected to a charging point. As each of the vehicles/batteries is connected, it sends a data transmission containing vehicle/battery data, geographic location data and any other data required for the purposes of billing and taxation is sent to the power provider 2010 indicating that the vehicle/battery requires charging. The power provider control system then reviews the individual sliding scale billing subscription for the vehicle/battery being connected, and sends a data transmission back, indicating the rate of charge for the battery allowed, depending on the sliding scale billing subscription, the vehicle/battery exemptions and the power loading of area A 2020. Thus each of the vehicle/batteries 2080, 2090, 2100 and 2110 will be receiving individual data transmissions containing power charging rate instructions from the power provider, the instruction depending on the factors of individual vehicle/battery sliding scale billing subscription, vehicle/battery exemptions and the power loading of area A 2020.

The vehicles/batteries 2120, 2130, 2140 and 2150 in area B 2030 will also be receiving individual data transmissions containing charging rate instructions from the power provider, the instruction depending on the factors of individual vehicle/battery sliding scale billing subscription, vehicle/battery exemptions and the power loading of area B 2030.

Each of the individual vehicles/batteries in both areas A 2020 and B 2030 will receive update data transmissions from the power provider, allowing them to alter their vehicle/battery charging rates, as power loading in areas A 2020 and B 2030 allow. In every individual case, the data contained in the data transmission will control the maximum vehicle/battery charging rate. Should the owner/driver require a lower charging rate than the one authorized, the vehicle/battery control system will default to the lower charging rate.

In this manner, power loading in areas A 2020 and B 2030 are controlled by the power provider 2010, and also allow power supplied for vehicle/battery charging to be recorded and billed, along with any Federal or local taxation requirements for power supplied.

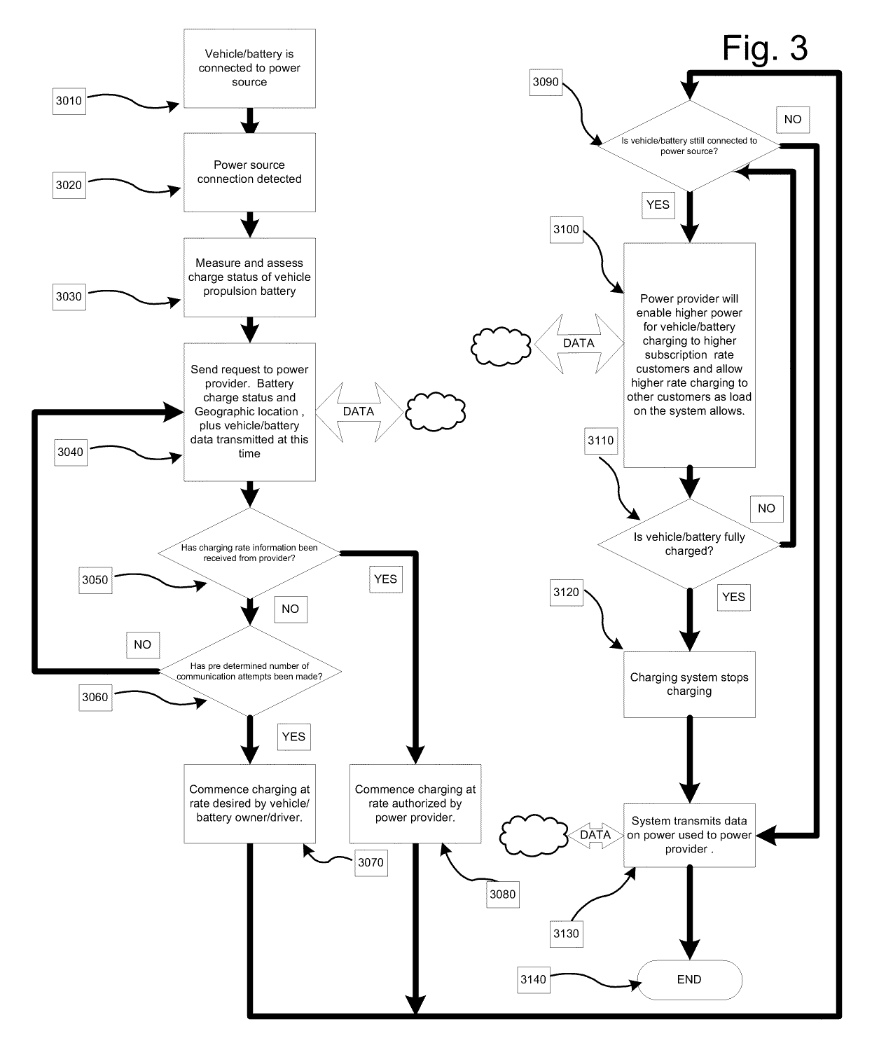

FIG. 3 Describes the way in which the individual vehicle/battery charging control systems communicate with and are monitored and controlled by the control system of the power providers.

In 3010 the vehicle/battery is connected to a power source for the purposes of charging the vehicle/battery. In 3020 the power connection is detected by the control system and in 3030 the control system measures and assesses the vehicle/battery charging requirements.

In 3040 the control system sends a data transmission to the power provider, the data including battery charge state, geographic location, vehicle/battery data, plus any other data required by the power provider. In 3050 the control system checks to see if a response has been made for charging instructions by data transmission from the power provider. If the instructions have not been received, the control system checks the number of times the request has been sent out at 3060. If a pre-determined number of data transmission communication attempts have not been exceeded the system sends out a further request at 3040 and cycles back through steps 3050 to 3060. If the pre-determined number of data communications is exceeded at step 3060, the control system commences charging the vehicle/battery at 3070 at the maximum rate requested by the vehicle/battery owner/driver. In the case of this communication failure with the power provider, the vehicle/battery charging control system will record and store the power usage along with vehicle/battery data, geographic location data and any other data required for the purposes of billing and taxation and report it to the power provider at the next successful communication for billing purposes. This stored data can also be accessed at any time by an authorized third party location for the purposes of mileage and power use verification.

If at 3050 the data transmission from the power provider has been received, then the control system enables charging the vehicle/battery at 3080 at the charge rates transmitted by the power provider.

At 3090, the control system is monitoring the power input; should the vehicle/battery become disconnected, the control system will send a data transmission to the power provider at 3130 and stops the charging system at 3140. Should the power be re-applied, the system will default to step 3010. All power use events will be recorded by the control system. This stored data along with vehicle/battery data, geographic location data and any other data required for the purposes of billing and taxation, can also be accessed at any time by an authorized third party location for the purposes of mileage and power use verification.

At 3090 if the control system indicates that the power is still connected, the control system at 3100 receives updates from the power provider control system by way of data transmission which will adjust the charge rate of the vehicle/battery up or down depending on the power loading in the geographic area up to the maximum charge rate requested by the vehicle/battery owner/driver.

At 3110, the control system checks whether the vehicle/battery is fully charged. If the battery is not fully charged the system cycles back through steps 3090 to 3110 until the vehicle/battery is fully charged. Once it is established that the vehicle/battery is fully charged at 3110, the control system stops charging the vehicle/battery at 3120 and sends a data transmission containing data on power used, vehicle/battery data, geographic location data and any other data required for the purposes of billing and taxation to the power provider at 3130, the system then stops at 3140 until the next time the vehicle/battery is connected to a charging point. All power use events will be recorded by the control system. The stored power use data as well as vehicle/battery data, geographic location data and any other data required for the purposes of billing and taxation can also be accessed at any time by an authorized third party location for the purposes of mileage and power use verification.

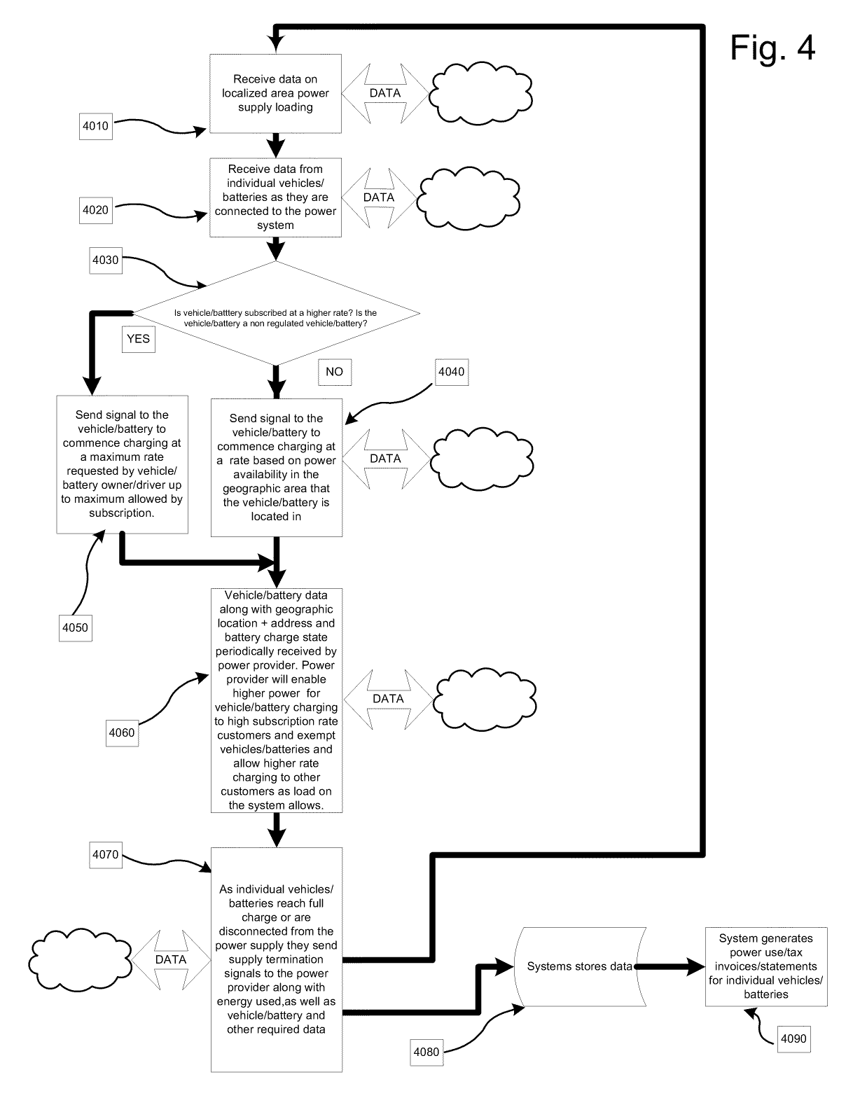

FIG. 4 describes the way in which the control system of the power provider controls and monitors individual vehicles/batteries, recording power usage and generating billing for power usage and taxation purposes.

At 4010, the control system is receiving data on geographic area power utilization and availability.

At 4020, the control system is receiving vehicle/battery data, geographic location data, and any other data required for the purposes of billing and taxation from individual vehicles/batteries requiring power for charging as they are connected to the system.

At 4030, the system checks to see whether the vehicle/battery is registered at a high sliding scale billing rate, or is an exempted vehicle/battery. If either of these checks is positive the control system sends out a data transmission at 4050 to the vehicle/battery to commence charging at the maximum rate requested by the owner/ driver of the vehicle/battery. At 4030, if the vehicle/battery is not exempt and is not subscribed at a high sliding scale billing rate the control system sends out a data transmission to the vehicle/battery at 4040 to commence charging at a rate based on power availability in the geographic area within which the vehicle/battery is located.

At 4060, the control system receives updates on the power distribution loading for the geographic area and sends out data transmissions, instructing vehicles/batteries connected to the power system to vary their charge rates depending on the loading on the system and power availability.

At 4070, as individual vehicles/batteries become fully charged they disconnect from the supply after sending out power use data, vehicle/battery data, geographic location data and any other data required for the purposes of billing and taxation. At 4080, the control system stores the data on power supplied, sliding scale billing rates, vehicle/battery data, geographic location data and any other data required for the purposes of billing and taxation. At 4090, the control system interfaces with the billing system to generate individual vehicle/battery power use and tax billing.

At 4070, the system cycles back through to 4010 since the localized power provider control sequence is continuous with vehicles/batteries being connected and disconnected from the network as they require charging.

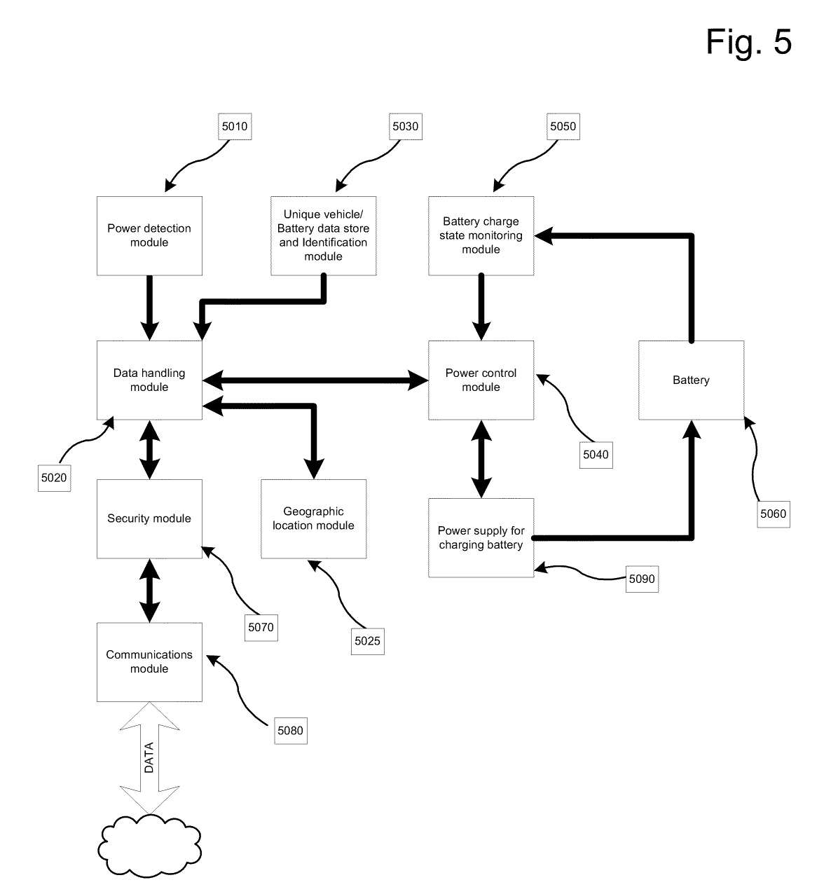

FIG. 5 is a block diagram describing the control system of the invention based at the vehicle/battery location. In practice the major blocks of this system are contained within the vehicle/battery.

When the vehicle/battery is connected to a power source the power detection module 5010 detects the connection and sends a signal to the data handling module 5020. The data handling module 5020 retrieves the unique vehicle/battery data from the identification module 5030 and requests data from the power control module 5040. The power control module 5040 requests and receives data from the battery charge state monitoring module 5050. The power control module 5040 sends the battery status to the data handling module 5020. The data handling module 5020 then sends all of this data plus geographic location data from the geographic location module 5025 via the security module 5070 to the communications module 5080 which sends a data transmission to the power provider.

When the power provider sends back a data transmission containing battery charging rate data, it is received by the communications module 5080 and is passed via the security module 5070 to the Data handling module 5020. The information is passed from the data handling module 5020, to the power control module 5040, which then controls the charge rate of the power supply for charging battery 5090, to charge at the rate authorized by the power provider.

The battery charge state module 5050 monitors the battery 5060 charge state continuously, and once the battery 5060 is fully charged sends a signal to the power control module 5040 which instructs the power supply 5090 to stop charging. The power control module 5040 also sends data to the data handling module 5020 which sends information on power used, vehicle/battery data, geographic location data and any other data required for the purposes of billing and taxation to the communications module 5080 via the security module 5070. The communications module sends a data transmission containing this data to the power provider. The control system stores power used, vehicle/battery data, geographic location data and any other data required for the purposes of billing and taxation, so that it can also be accessed at any time by an authorized third party location for the purposes of mileage and power use verification.

The power provider sends back an acknowledgement data transmission and the control system resets until the next time a power connection event is detected at 5010.

In the event that there is no communication possible at the end of the battery charge cycle described above or if no acknowledgement is received, the power use data will be stored along with vehicle/battery data, geographic location data and any other data required for the purposes of billing and taxation, to be transmitted when communications between the control system and the power provider are restored. The control system stores power usage vehicle/battery data, geographic location data and any other data required for the purposes of billing and taxation so that it can also be accessed at any time by an authorized third party location for the purposes of mileage and power use verification.

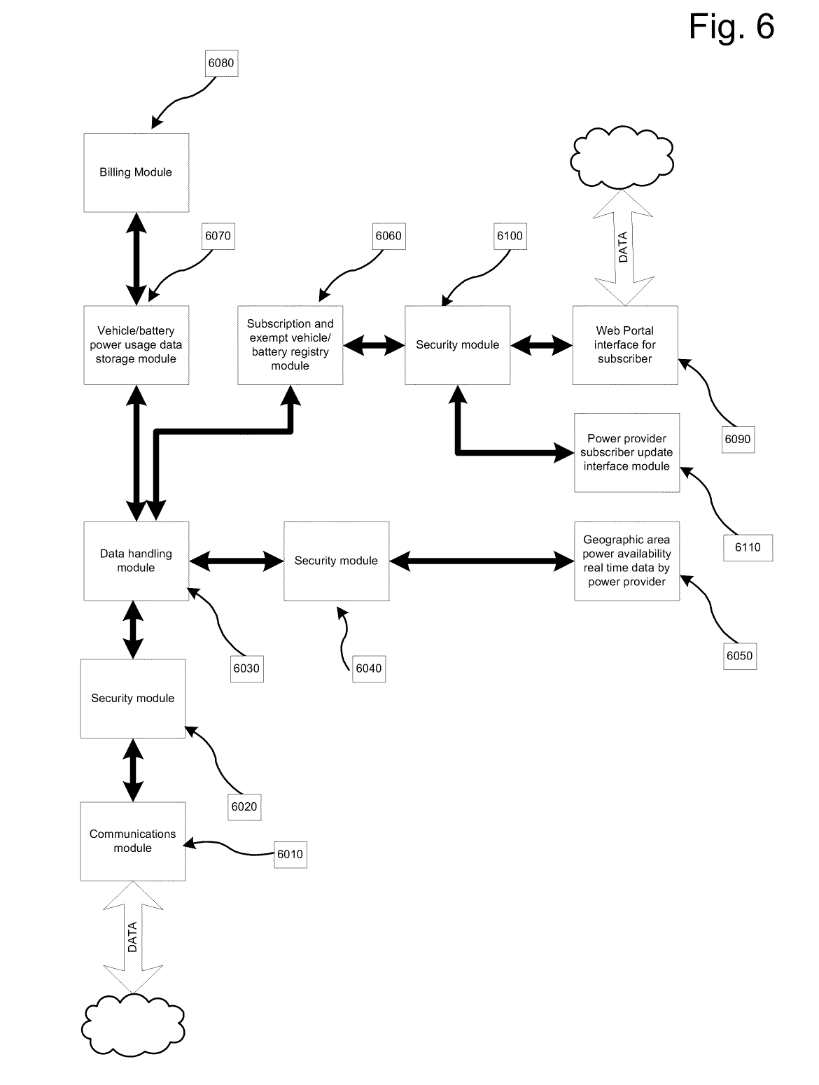

FIG. 6 is a block diagram describing the control system of the invention based at the power provider location.

The communications module 6010 receives data transmission signals from individual vehicles/batteries requesting power, and also containing vehicle/battery data, geographic location data and any other data required for the purposes of billing and taxation. The communications module 6010 communicates the data transmission to the data handling module 6030 via a security module 6020. The data handling module 6030 is also receiving Geographic area power availability data from 6050 directly from the power provider via a security module 6040.

The data handling module 6030 receives the individual vehicle/battery power request and retrieves vehicle/battery sliding scale billing subscription data, and where appropriate exemption data from the Sliding scale billing subscription and exempt vehicle/battery registry module 6060.

Based on all available data, the data handling module 6030 then sends out a data transmission containing charge rate authorization to the individual vehicle/battery, based on power availability in the geographic area, individual vehicle/battery Sliding scale billing subscription data, and vehicle/battery exemption status. This data is sent from the data handling module 6030 via the security module 6020 to the communications module 6010 which sends the data transmission to the individual vehicle/battery.

If the power to the individual vehicle/battery is disconnected or if the vehicle/battery has completed charging, a data transmission containing power use data, vehicle/battery data, geographic location data, and any other data required for the purposes of billing and taxation, is sent from the control system of the vehicle/battery, which is received by the communications module 6010 and sent via the security module 6020 to the data handling module 6030. The data handling module 6030 sends the data to the vehicle/battery power usage data storage module 6070 where it can be accessed periodically for billing/taxation purposes by the power provider billing module 6080.

The system will from time to time send out data transmissions to the individual vehicles/batteries in order to adjust the power grid loading in the geographic area, reducing individual vehicle/battery charge rates at high loading times and allowing increased charge rates at times when more power in the Geographic area is available.

The vehicle/battery owner/driver is able to control subscription rates for power used by the vehicle/battery by means of subscribing to different sliding scale billing rates via a secure web subscriber interface portal 6090. Additionally there is an interface at 6110 to enable the power provider to interface with and make adjustments to the control system and the data contained within it.

We claim:

1. A system for remotely monitoring, recording and controlling the power supplied to electrical vehicles/batteries comprising:
means for communicating vehicle/battery data to a power provider or their agents;
means for a power provider, their agents or third party location to identify a vehicle/battery geographic location;
means for controlling the charge rate on a vehicle/battery via a data transmission from a power provider or their agents;
means for transmitting, monitoring and recording power used for the purposes of charging a vehicle/battery;
means for a vehicle/battery to store and transmit vehicle/battery data;
means for controlling charge rates on vehicles/batteries within a geographic electrical supply area or areas;
means for reviewing and altering charge rates on vehicles/batteries within a Geographic electrical supply area or areas dependent on the power supply loading in that area or areas;
means for setting individual vehicle/battery charge rates within a geographic electrical supply area;
means for enabling individual vehicle/battery sliding scale billing for electrical power used for electric vehicle propulsion;
means for enabling a power provider or their agents to identify an exempted vehicle/battery;
means for an owner/driver to alter individual vehicle/battery sliding scale subscription rates for electrical power used for electric vehicle propulsion;
means for monitoring, recording and reporting power used for electric vehicle propulsion for the purposes of collecting taxes;
means for monitoring, recording and reporting power used for electric vehicle propulsion for the purposes billing for power used for such purpose;
means for a vehicle/battery to communicate with and request power from a power provider.

2. The system according to claim 1 further comprising:
means for a third party location to retrieve vehicle/battery data from a vehicle/battery for the purposes of assessing and verifying reported use of electrical power for electric vehicle propulsion.
